(19) United States
(12) Patent Application Publication
(10) Pub. No.: US 2008/0319955 A1
(43) Pub. Date: Dec. 25, 2008

(54) WEB BROWSER PAGE RATING SYSTEM

(76) Inventors: John Douglass, Bendigo (AU); Nathan Martyn, Bendigo (AU); John Moetteli, Geneva (CH)

Correspondence Address: MOETTELI & ASSOCIATES SARL, ST. LEONHARDSTRASSE 4, ST. GALLEN, CH-9000, CH

(21) Appl. No.: 12/202,442

(22) Filed: Sep. 2, 2008

Related U.S. Application Data
(63) Continuation of application No. 09/970,812, filed on Oct. 4, 2001.
(60) Provisional application No. 60/237,510, filed on Oct. 4, 2000.

(51) Int. Cl. G06F 17/30

(52) U.S. Cl. 707/3; 707/E17.108

(57) ABSTRACT

A computerized web page rating method encoded on a computer-readable medium is provided. The method operates client-side in network browser software, rating the relevancy of web pages visited in a project-based browsing network research session. The ratings of web pages are calculated using a relevancy algorithm selected from a group of algorithms consisting of (1) the application of a rating style or formula to user-defined keywords previously saved in association with a project and (2) manual rating based on visual review of the contents of the web page.

### STATEMENT OF RELATED APPLICATIONS

This application is a continuation of U.S. application Ser. No. 09/970,812, of the same title, and thereby benefits from the parent's claim of priority to U.S. Provisional Application No. 60/237,510, the content of which is incorporated herein by reference thereto.

### FIELD OF THE INVENTION

This invention relates to keyword rating routines, and more particularly, keyword rating routines for ascertaining the relevance of a particular Internet web page to a research theme.

### BACKGROUND OF THE INVENTION

The abundance of information on the web has given rise to a myriad of search engines. Most, if not all, search engines return search results in order of relevancy given the submitted keywords. Each search engine determines the relevancy of a page given a number of criteria. While this assists the user in locating the information he is looking for, there are limitations when applied to project-based browsing, a method of browsing as described in PCT/US00/17409, the content of which is hereby incorporated herein by reference. Some of these limitations include the followings:
(a) The relevancy of pages using conventional solutions can not be viewed by supervising members of a project;
(b) There is a lack of detailed information regarding the frequency and location of matched keywords;
(c) A user can submit arbitrary keywords to the search engine thus potentially causing the user to loose focus and become distracted when non-project-related search engine results are returned;
(d) Due to the demands placed on search engines and the large numbers of pages requiring indexing (for rating purposes), indexing information can quickly become obsolete due to changes in the original page. Moreover, it can take months/days/hours for a search engine to index a web page.

The ability to draw a user's attention to matched keywords was implemented in Microsoft Developer Network service (MSDN) and the Google search engine (www.google.com), where keyword matches are highlighted. The MSDN keyword utility, however, is implemented into the on-line browsing of Microsoft's software development documents. The Google utility is implemented on the server-side. Neither integrates such features into a web browser.

Therefore, what is needed is a rating method that rates pages that a user views using a browser, the rating being a reliable indication of the relevancy of the pages viewed in relation to projects.

### SUMMARY OF THE INVENTION

A computerized web page rating method encoded on a computer-readable medium is provided. The method operates client-side in network browser software, rating the relevancy of web pages visited in a project-based browsing network research session. The ratings of web pages are calculated using a relevancy algorithm selected from a group of algorithms consisting of (1) the application of a rating style or formula to user-defined keywords previously saved in association with a project and (2) manual rating based on visual review of the contents of the web page.

Further, detected keywords are used to rate each web document visited in real-time. This rating is based on the currently selected rating style, from which there are several to choose from. Each rating style are similar to those used by actual search engines to retrieve web documents given a list of keywords. Each rating style will rate a Web page or downloaded document based on a series of criteria to determine the “relevancy” in relation to the keywords and thus the project. Therefore, the higher the rating, the more relevant a particular page may be to a project.

### BRIEF DESCRIPTION OF THE DRAWINGS

FIG. 1 is a flowchart of the method of the invention.

FIG. 2 is a screen shot of the Project Properties Dialog of the invention.

FIG. 3 is a schematic diagram of the invention.

FIG. 4 is a screen shot of the Keyword highlighting feature of the invention.

FIG. 5 is a screen shot showing the manual rating feature of the invention.

FIG. 6 is a screen shot of a listing of documents rated by the method of the invention.

### DETAILED DESCRIPTION OF THE PREFERRED EMBODIMENT

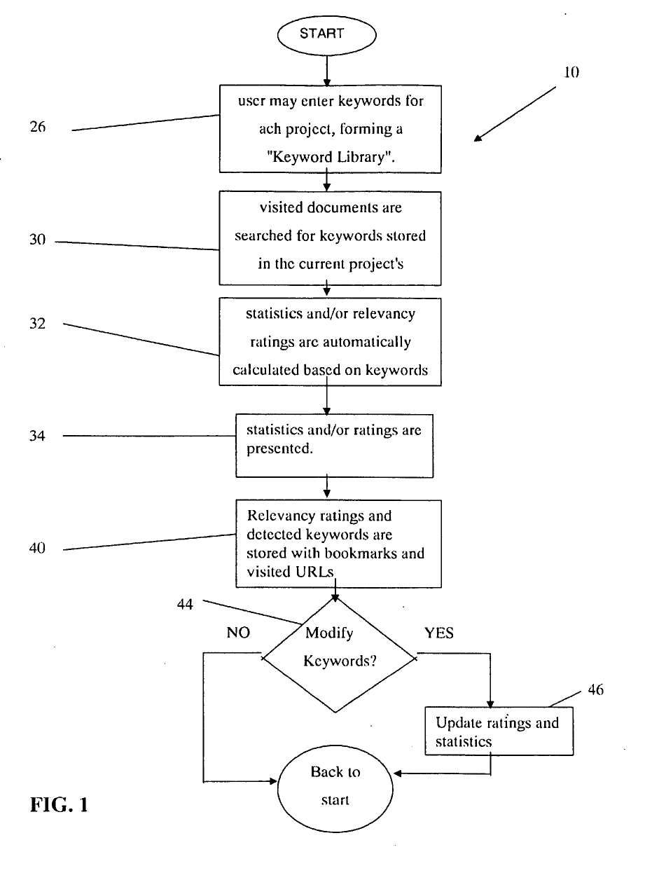

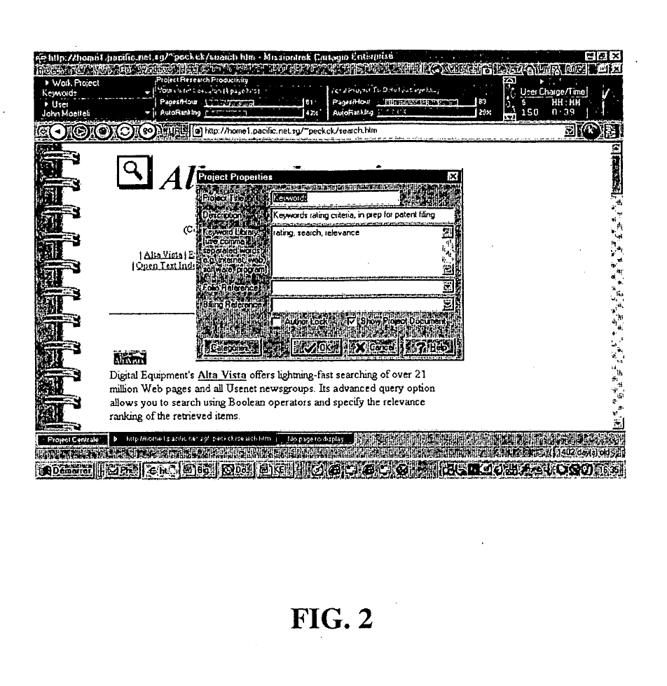

Referring now to FIGS. 1 and 2, a computerized method 10 encoded on a computer-readable medium, which automatically rates web pages 12 based on pre-designated, project-based keywords 14 is provided which is not dependent on the effectiveness of a user's research during research in which research results are automatically saved in association with a project 20 (i.e., Project-Based Browsing). In FIG. 2, the general inputs solicited of the user upon the definition of a project 20, are shown. This method 10 allows a “Keyword Library” 16 to be associated with a project 20 upon project creation (and optionally modified during project execution), whereby the keywords 14 are used to search each visited document 12. The method 10 also provides users with the ability to quickly view and locate project keywords 14 in the current page when browsing.

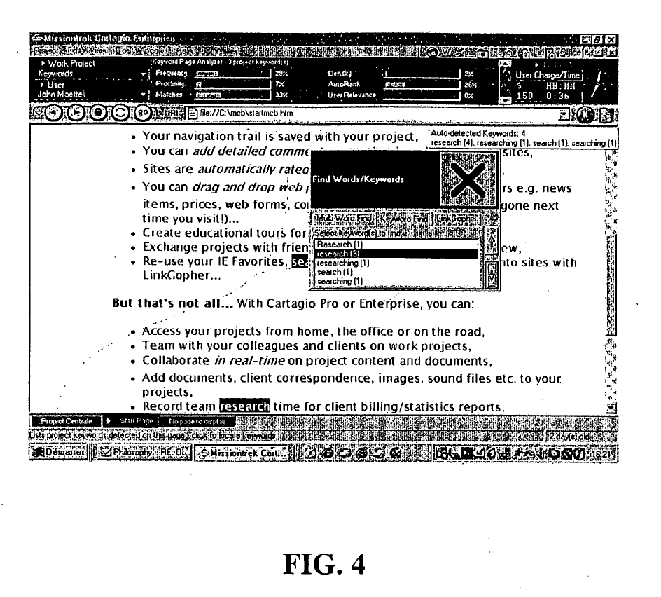

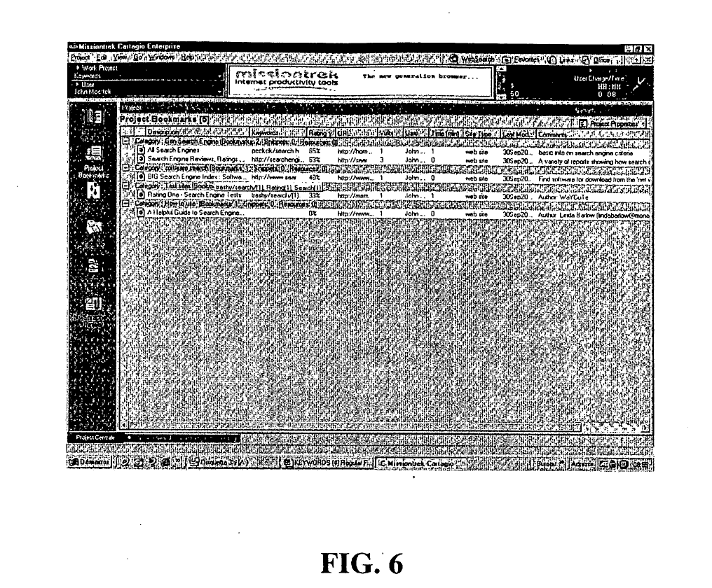

Further, detected keywords 22 (shown in FIG. 4) are used to rate each web document 12 visited in real-time. This rating 24 (shown in FIG. 6) is based on the currently selected rating style, from which there are several to choose from (described in more detail below). Each rating style is similar to those used by actual search engines to retrieve web documents given a list of keywords. Each rating style will rate a Web page based on a series of criteria to determine the “relevancy” in relation to the keywords and thus the project. Therefore, the higher the rating 24, the more relevant a particular page 12 may be to a project 20.

The method 10 includes the following steps. In a first step 26, a user enters keywords 14 (including provision for whole-word matches and case-sensitivity) into a Project Properties Dialog 28 for the project 20 associated with a client or theme (such as “Keywords” 20), thus forming a “Keyword Library” 16 which is saved in association with the PBB file. In a second step 30, the word(s), phrase(s) or symbol(s) of visited documents 12 such as HTML and XML pages (including such document's non-visible text such as meta-tags, URIs and email addresses) are scanned for words, phrases or symbols that match keywords 14 stored in the current project's Keyword Library 16. In a third step 32, a computer processor (on a PC on which the software is running) applies calculation logic stored in the method 10 to automatically calculate statistics and/or relevancy ratings 24 based on keywords 14 found in the document 12 (using algorithms for frequency, location, density, proximity and matches, for example). In an optional fourth step 34, statistics and/or ratings 24 are presented in visual form, such as in via bar graph display 36 (shown in FIG. 4). In a fifth step 40, relevancy ratings 24 and detected keywords 22 are stored as in a data field of a bookmark structure 42 (shown in FIG. 6) which includes visited URLs, and they may at any time be viewed or sorted/ordered based on a selected ratings style. For example, as shown in FIG. 6, the bookmark structure 42 is organized by descending relevancy. Thus, users are provided with the tools to re-visit, find, and refer to documents that are more relative to the project at hand. In an optional sixth step 44, the user may re-display the Project Properties Dialog 28 and modify the keywords 14. In an optional seventh step 46, if a modification is made, ratings and statistics are automatically recalculated and updated in the bookmark structure 42 based on the latest contents of the keyword library 16.

In the fourth step 34, statistics may be presented in six or more ratings styles (including a custom system), each providing visited documents with a rating between 0 and 100% (e.g., ratings 24 of FIG. 6). These ratings styles reflect the relevancy of visited web documents 12 to the current project 20. At any point, users may change their selection of a ratings style (by for example, right clicking the rating 24 and selecting from a menu of rating styles, to view updated ratings for displayed bookmarks and URLs. A mix of ratings styles may be selected for similarity with the (unpublished) ratings mechanisms of several popular search engines (Alta Vista, Excite, Hotbot, Infoseek and Lycos).

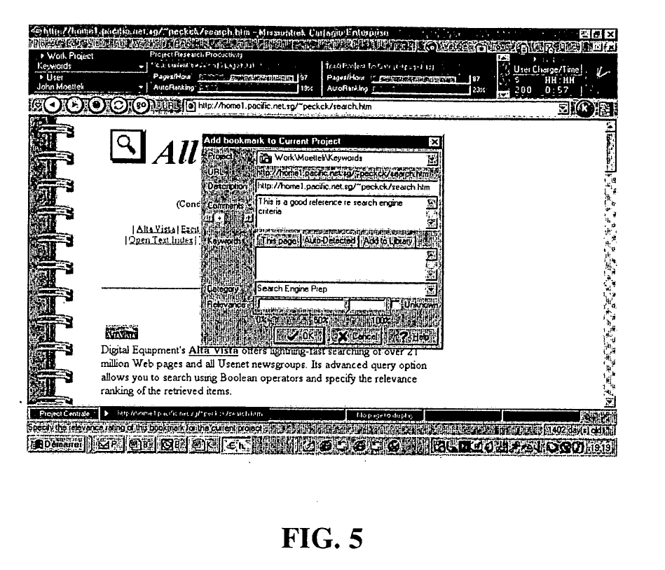

Referring now to FIG. 5, in a feature of the invention, when bookmarking a page, users can optionally extend the existing project keyword library 16 with additional terms.

In another feature of the invention, users have the ability to optionally specify their own rating 50 of how relevant a URL is to a project 20 when bookmarking or revisiting a bookmarked page.

Referring now to FIG. 4, a screen shot of a browser GUI 48 is shown displaying a sample web page 12 visited during a project-based browsing research session. Users may at any time view the auto-detected keywords 22 in a document 12 through any of three or more ways; 1) via a hint activated caption 52 displaying all matches found and frequencies; 2) via a custom find dialog accessible through clicking on the find tab 54; 3) via a navigation history and/or bookmark list, such as that shown in FIG. 6, where auto-detected words and ratings are stored for each URL visited.

In the first means for viewing auto-detected keywords 22, the caption 52 displays auto-detected keywords in a document 12, each keyword 14 matched being displayed alongside the frequency it occurred and an indication of whether the keywords are visible or not (the fact that a keyword is hidden may be noted with the symbol “h”, after the number representing the frequency). Any selection of keywords 14 may be made, whereby only those selected are searched for, the selected keyword being highlighted in red 56 or italicized. This feature allows users to efficiently navigate to the location of found keywords 22 in a document 12, enabling a quicker assessment of its relevancy. To further make keywords easier to locate, each match is highlighted with, say, a black background, enabling quick identification of relevant sections even when scrolling through the document, thus eliminating having to read every word.

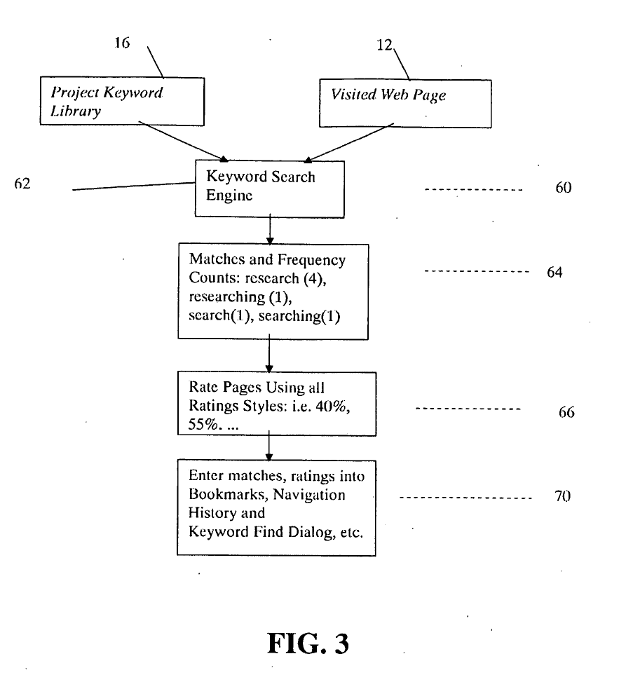

Referring now to FIG. 3, a schematic of the method 10 of the invention is shown. In a first step 60, the keyword library 16 and the contents of the visited document 12 are input into a keyword search engine 62. In a second step 64, the number of matches and frequency counts are calculated. In a third step 66, the visited pages 12 are rated using a variety of rating styles. In a fourth step 70, the matches and ratings are made available for display at the command of the user, the user being able to define the rating style for the rating of the visited page 12.

Each of the rating styles supported are loosely derived from actual search engines used by World Wide Web users to retrieve Web documents given keywords. Each factor considered when rating a page is defined below (the following not intended to provide a complete list of factors, only the more important ones).
Meta-data: Indicates that the rating system searches meta-data of a Web page. A Web page will rank higher if any keywords specified occur in any of this data (i.e. URL, Title & Meta-tags).
Frequency: Indicates that the rating system takes into consideration the number of times each keyword appears in a document. Therefore, the greater frequency of a keyword, the higher the rating.
Matches: Indicates that the rating system takes into consideration the number of keywords that were located in a document. Therefore, the greater number of keywords that were found at least once, the higher the rating.
Proximity: Indicates that the rating system takes into consideration the proximity (closeness) of located keywords in a document. Therefore, the closer the matched keywords, the higher the rating.
Density: Indicates that the rating system takes into consideration the number of keywords matched in relation to the document size. Therefore, a page which contains an equal number of matched keywords will receive a higher rating than another if the size of the page is smaller—thus a greater density.

Referring now to FIG. 5, in an alternate embodiment of the invention, the method 10 provides the user with a bookmark interface 80, displayed through clicking the displayed page 12 to be ranked with the right mouse button. This interface 80 allows the user to override any manual relevancy calculation by inputting a manual relevancy via, for example, the slide bar 50. Thus, the method 10 of the invention allows users to view projects ranked objectively, using a relevancy algorithm or subjectively, using a manually set ranking as shown in this figure. The manually set ranking may be of more value to the extent that those that are setting the ranking have experience or can more effectively assess the true relevancy of a particular web resource.

Multiple variations and modifications are possible in the embodiments of the invention described here. Although certain illustrative embodiments of the invention have been shown and described here, a wide range of modifications, changes, and substitutions is contemplated in the foregoing disclosure. In some instances some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A computerized method encoded on a computer-readable medium, the method operating client-side in network browser software, wherein the method includes the steps of:
(a) scanning a downloaded web page for keywords which match keywords in a previously saved library of project-associated keywords; and
(b) displaying found keywords in a list inside a dialog box that allows the user to select a keyword in the list to locate the auto-detected keywords in the downloaded document.

2. The method of claim one, including the further step of measuring relevancy of the downloaded document visited in a project-based network research session according to the keywords detected in the document, such detected keywords determining the downloaded document's relevancy to a particular project, theme, or session, the measured relevancy being saved in association with the downloaded document, and measuring the

3. The method of claim 2, wherein the relevancy is measured using a sub-method selected from a croup of sub-methods consisting of (1) scanning for keywords present in the downloaded document which match keywords stored in a keyword library previously saved in association with the project, theme, or session, followed by the application of a relevancy-measurement style or formula to the keywords of the keyword library found in the downloaded document and (2) manual setting by the user of relevancy of the downloaded document to the project, theme, or session, based on a visual review by the user of the contents of the downloaded document.

4. The method of claim 1 wherein detected keywords found in the downloaded document are automatically highlighted.

5. The method of claim 3 wherein the relevancy-measurement style or formula is selected from a group of styles or formulas consisting of (a) those used by search engines; (b) a custom style; (c) simple keyword number counts optionally applying statistical weighting factors; (d) styles or formulas evaluating existing meta-data; (c) styles or formulas evaluating frequency of occurrence of specific keywords; (f) styles or formulas evaluating matches; (g) styles or formulas evaluating proximity; and (h) styles or formulas evaluating density.

6. The method of claim 1, wherein the existing project keyword library is editable by adding additional terms or deleting existing terms, during such actions as bookmarking.

7. The method of claim 3 wherein the method includes relevancy specifying means by which a user specifics relevancy according to her own rating of relevancy of an URL to a project when bookmarking or revisiting a bookmarked page and further providing means for ordering results on a display according to such relevancy.

8. The method of claim 7 wherein the means is a slide bar.

9. The method of claim 1 wherein the method includes means for viewing the auto-detected keywords in a document.

10. The method of claim 9, wherein the means is selected from a group of means consisting of (a) a caption displaying all matches found and associated match frequencies, (b) a dialog and (c) a navigation history and bookmark list in which auto-detected words and ratings are stored for each URL visited.

11. The method of claim 1, wherein display means is provided for displaying a distribution of the number of occurrences of keywords within each downloaded page in the form of a graph.

12. The method of claim 1, wherein locating means is provided which, by clicking on a detected keyword, the downloaded document is automatically scrolled to display that keyword in highlighted form.
